(19) United States
(12) Patent Application Publication
(10) Pub. No.: US 2026/0192272 A1
(43) Pub. Date: Jul. 9, 2026

(54) APPARATUS FOR MANUFACTURING CARBON NANOTUBE WIRE AND METHOD OF MANUFACTURING CARBON NANOTUBE WIRE

(71) Applicants: Sumitomo Electric Industries, Ltd., Osaka-shi, Osaka (JP); UNIVERSITY OF TSUKUBA, Tsukuba-shi, Ibaraki (JP)

(72) Inventors: Toshihiko FUJIMORI, Osaka-shi (JP); Hirotaka INOUE, Osaka-shi (JP); Takamasa ONOKI, Osaka-shi (JP); Takeshi HIKATA, Osaka-shi (JP); Soichiro OKUBO, Osaka-shi (JP); Junichi FUJITA, Tsukuba-shi (JP)

(73) Assignees: Sumitomo Electric Industries, Ltd., Osaka-shi, Osaka (JP); UNIVERSITY OF TSUKUBA, Tsukuba-shi, Ibaraki (JP)

(21) Appl. No.: 19/127,862

(22) PCT Filed: Dec. 7, 2023
(86) PCT No.: PCT/JP2023/043814

§ 371 Date: May 7, 2025

(30) Foreign Application Priority Data
Dec. 8, 2022 (JP) 2022-196278

(51) Int. Cl. B01J 8/08; C01B 32/168; D01D 5/06; D01F 9/12

(52) U.S. Cl. CPC B01J 8/085; C01B 32/168; D01D 5/06; D01F 9/12; B01J 2208/00893; B01J 2208/06; D10B 2101/122

(57) ABSTRACT

An apparatus for manufacturing a carbon nanotube wire includes a first tube, a second tube, a first supply portion, and a second supply portion. The first tube includes a first inner circumferential surface and an outer circumferential surface. The outer circumferential surface surrounds the first inner circumferential surface. The second tube includes a second inner circumferential surface. The second inner circumferential surface surrounds the outer circumferential surface. The second inner circumferential surface extends along the outer circumferential surface. The first supply portion supplies a carbon nanotube source material and chlorosulfonic acid to the inside of the first tube. The second supply portion supplies a coagulant liquid to the inside of the second tube. The first tube includes a first end. The first end is arranged inside the second tube.

### TECHNICAL FIELD

The present disclosure relates to an apparatus for manufacturing a carbon nanotube wire and a method of manufacturing a carbon nanotube wire. The present application claims priority to Japanese Patent Application No. 2022-196278 filed on Dec. 8, 2022, the entire contents of which are hereby incorporated by reference.

### BACKGROUND ART

Japanese National Patent Publication No. 2011-502925 (PTL 1) describes a manufacturing method of obtaining a carbon nanotube article by removing chlorosulfonic acid from a carbon nanotube solution in chlorosulfonic acid.

### CITATION LIST

### Patent Literature

PTL 1: Japanese National Patent Publication No. 2011-502925

### SUMMARY OF INVENTION

An apparatus for manufacturing a carbon nanotube wire according to the present disclosure includes a first tube, a second tube, a first supply portion, and a second supply portion. The first tube includes a first inner circumferential surface and an outer circumferential surface. The outer circumferential surface surrounds the first inner circumferential surface. The second tube includes a second inner circumferential surface. The second inner circumferential surface surrounds the outer circumferential surface. The second inner circumferential surface extends along the outer circumferential surface. The first supply portion supplies a carbon nanotube source material and chlorosulfonic acid to the inside of the first tube. The second supply portion supplies a coagulant liquid to the inside of the second tube. The first tube includes a first end. The first end is arranged inside the second tube.

### BRIEF DESCRIPTION OF DRAWINGS

FIG. 1 is a schematic front view showing a configuration of an apparatus for manufacturing a carbon nanotube wire according to a first embodiment.

FIG. 2 is an enlarged schematic cross-sectional view showing a region II in FIG. 1.

FIG. 3 is a schematic cross-sectional view along the line III-III in FIG. 2.

FIG. 4 is a schematic cross-sectional view showing a region surrounded by a second inner circumferential surface.

FIG. 5 is a flowchart schematically showing a method of manufacturing a carbon nanotube wire according to the first embodiment.

FIG. 6 is a schematic front view showing a step of forming a carbon nanotube wire.

FIG. 7 is an enlarged schematic cross-sectional view showing a region VII in FIG. 6.

FIG. 8 is a schematic diagram showing a configuration of an apparatus for manufacturing a carbon nanotube wire according to a second embodiment.

FIG. 9 is a schematic perspective view showing a method of evaluating a degree of orientation with polarized Raman spectroscopy.

FIG. 10 is a schematic diagram showing Raman spectra.

FIG. 11 is a diagram showing relation between a flow rate of slurry and a degree of orientation of a carbon nanotube wire in Example.

FIG. 12 is a scanning electron micrograph of a carbon nanotube wire according to a sample 1.

FIG. 13 is a scanning electron micrograph showing a surface of the carbon nanotube wire according to sample 1, as being enlarged.

FIG. 14 is a scanning electron micrograph of a carbon nanotube wire according to a sample 4.

FIG. 15 is a scanning electron micrograph showing a surface of the carbon nanotube wire according to sample 4, as being enlarged.

### DETAILED DESCRIPTION

### Problem to be Solved by the Present Disclosure

According to the manufacturing method described in PTL 1, a structure of a portion where the carbon nanotube solution and a coagulant merge is not clearly disclosed. In the portion where the carbon nanotube solution and the coagulant merge, clogging with carbon nanotubes may occur. An object of the present disclosure is to provide an apparatus for manufacturing a carbon nanotube wire and a method of manufacturing a carbon nanotube wire that can suppress clogging with carbon nanotubes.

### Advantageous Effect of the Present Disclosure

According to the present disclosure, an apparatus for manufacturing a carbon nanotube wire and a method of manufacturing a carbon nanotube wire that can suppress clogging with carbon nanotubes can be provided.

### Description of Embodiments of the Present Disclosure

Embodiments of the present disclosure will initially be listed and described.

(1) An apparatus 100 for manufacturing a carbon nanotube wire according to the present disclosure includes a first tube 10, a second tube 20, a first supply portion 1, and a second supply portion 2. First tube 10 includes a first inner circumferential surface 12 and an outer circumferential surface 11. Outer circumferential surface 11 surrounds first inner circumferential surface 12. Second tube 20 includes a second inner circumferential surface 22. Second inner circumferential surface 22 surrounds outer circumferential surface 11. Second inner circumferential surface 22 extends along outer circumferential surface 11. First supply portion 1 supplies a carbon nanotube source material and chlorosulfonic acid to the inside of first tube 10. Second supply portion 2 supplies a coagulant liquid 92 to the inside of second tube 20. First tube 10 includes a first end 13. First end 13 is arranged inside second tube 20.

Thus, before slurry 94 and coagulant liquid 92 merge, a flow of each of slurry 94 and coagulant liquid 92 is rectified along a direction of extension of second inner circumferential surface 22. Therefore, a carbon nanotube wire 200 is formed along the direction of extension of second inner circumferential surface 22 and formed carbon nanotube wire 200 flows in the direction of extension of second inner circumferential surface 22. Entanglement of carbon nanotube wire 200 can thus be suppressed. Consequently, clogging with carbon nanotubes in apparatus 100 for manufacturing a carbon nanotube wire can be suppressed.

(2) According to apparatus 100 for manufacturing a carbon nanotube wire according to (1), coagulant liquid 92 may contain acetone. Chlorosulfonic acid is highly soluble in acetone. Therefore, in mixing of the carbon nanotube source material, chlorosulfonic acid, and coagulant liquid 92, coagulation of the carbon nanotube source material can be promoted. Consequently, a flow rate of slurry can be increased. Therefore, a degree of orientation of carbon nanotube wire 200 can be improved.

(3) Apparatus 100 for manufacturing a carbon nanotube wire according to (1) or (2) may further include a portion where the carbon nanotube source material and the chlorosulfonic acid are agitated while they are heated. Thus, the carbon nanotube source material can more uniformly be dispersed in slurry 94. Therefore, the degree of orientation of carbon nanotube wire 200 can be improved.

(4) According to apparatus 100 for manufacturing a carbon nanotube wire according to any of (1) to (3), a value calculated by dividing a first area by a second area may be not smaller than 0.0001 and not larger than 0.2, the first area representing a region surrounded by first inner circumferential surface 12 in a cross-section perpendicular to a direction of extension of second inner circumferential surface 22 and intersecting with each of first tube 10 and second tube 20, the second area representing an area of a region surrounded by second inner circumferential surface 22 in the cross-section.

(5) According to apparatus 100 for manufacturing a carbon nanotube wire according to any of (1) to (4), a length of a portion of first tube 10 arranged inside second tube 20 may be not shorter than 0 mm and not longer than 300 mm. Thus, when slurry 94 and coagulant liquid 92 merge, the flow of each of slurry 94 and coagulant liquid 92 is further rectified along the direction of extension of second inner circumferential surface 22. Consequently, clogging with carbon nanotubes can further be suppressed.

(6) According to apparatus 100 for manufacturing a carbon nanotube wire according to any of (1) to (5), second tube 20 includes a second end 23. Second end 23 is arranged opposite to second supply portion 2. A length between first end 13 and second end 23 in a direction of extension of second inner circumferential surface 22 may be not shorter than 10 mm and not longer than 2000 mm.

(7) A method of manufacturing a carbon nanotube wire according to the present disclosure includes steps below. Apparatus 100 for manufacturing a carbon nanotube wire according to any of (1) to (6) is prepared. The carbon nanotube source material, chlorosulfonic acid, and coagulant liquid 92 are mixed by supply of coagulant liquid 92 to the inside of second tube 20 while the carbon nanotube source material and chlorosulfonic acid are supplied to the inside of first tube 10.

(8) According to the method of manufacturing a carbon nanotube wire according to (7), in mixing, a flow rate of a liquid that flows inside first tube 10 may be not lower than 0.001 cm³/minute and not higher than 5 cm³/minute.

(9) According to the method of manufacturing a carbon nanotube wire according to (7) or (8), in mixing, a flow rate of a liquid that flows inside second tube 20 may be not lower than 0.02 cm³/minute and not higher than 100 cm³/minute.

(10) According to the method of manufacturing a carbon nanotube wire according to any of (7) to (9), carbon nanotube wire 200 formed in mixing may be wound up by using a bobbin 7. The number of rotations of bobbin 7 may be not less than 1 rpm and not more than 1000 rpm.

(11) According to the method of manufacturing a carbon nanotube wire according to any of (7) to (10), prior to mixing, slurry 94 may be prepared by agitating the carbon nanotube source material and chlorosulfonic acid while heating the carbon nanotube source material and chlorosulfonic acid. A concentration of the carbon nanotube source material in slurry 94 may be not lower than 0.01 weight % and not higher than 3 weight %.

### Details of Embodiment of the Present Disclosure

Details of an embodiment of the present disclosure will now be described with reference to the drawings. The same or corresponding elements in the drawings below have the same reference characters allotted and description thereof will not be repeated.

### First Embodiment

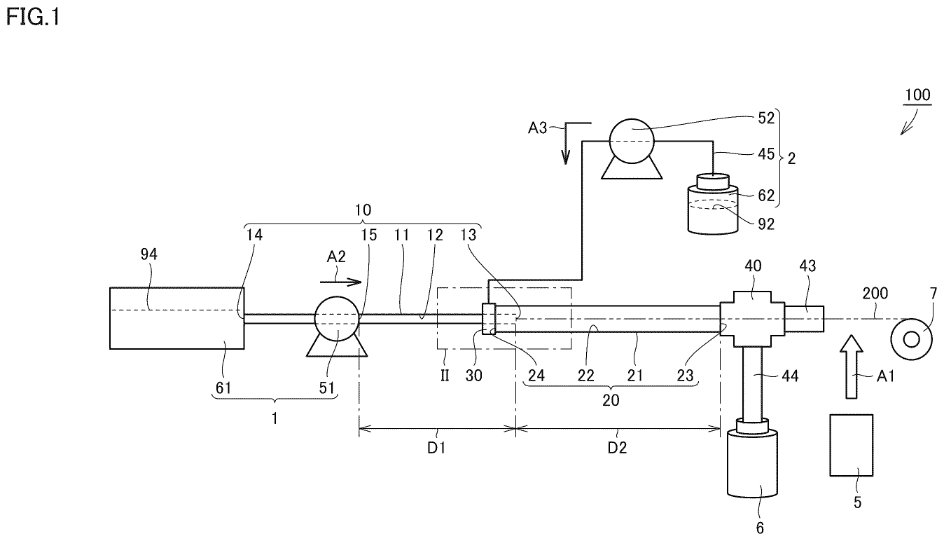

A configuration of apparatus 100 for manufacturing a carbon nanotube wire according to a first embodiment will initially be described. FIG. 1 is a schematic front view showing the configuration of apparatus 100 for manufacturing a carbon nanotube wire according to the first embodiment.

As shown in FIG. 1, apparatus 100 for manufacturing a carbon nanotube wire mainly includes first supply portion 1, first tube 10, second supply portion 2, second tube 20, a first connection portion 30, a second connection portion 40, a heat gun 5, a first bobbin 7, a waste liquid container 6, a third tube 43, and a fourth tube 44. Apparatus 100 for manufacturing a carbon nanotube wire is configured to form carbon nanotube wire 200 by mixing slurry 94 and coagulant liquid 92. Slurry 94 contains a carbon nanotube source material and chlorosulfonic acid. Coagulant liquid 92 contains, for example, acetone. A concentration of acetone in coagulant liquid 92 is, for example, not lower than 99.5 weight %.

First supply portion 1 is configured to supply slurry 94 to the inside of first tube 10. First tube 10 defines a flow channel of slurry 94. A part of first tube 10 is arranged inside second tube 20. The inside of second tube 20 includes a space surrounded by an end of second tube 20. From another point of view, in a direction of extension of first tube 10, an end of first tube 10 and an end of second tube 20 may be located substantially at the same position. Second supply portion 2 is configured to supply coagulant liquid 92 to the inside of second tube 20.

First connection portion 30 connects first tube 10 and second tube 20 to each other. Second connection portion 40 allows communication among second tube 20, third tube 43, and fourth tube 44. Third tube 43 guides formed carbon nanotube wire 200 to first bobbin 7. Formed carbon nanotube wire 200 is wound up around first bobbin 7. A diameter of first bobbin 7 is, for example, not smaller than 20 mm and not larger than 200 mm. The diameter of first bobbin 7 refers to a diameter of a portion of first bobbin 7 where carbon nanotube wire 200 is wound.

Heat gun 5 dries formed carbon nanotube wire 200. Specifically, as shown in FIG. 1, heat gun 5 sends hot air in a direction shown with a first arrow A1, to between third tube 43 and first bobbin 7. The direction shown with first arrow A1 may be perpendicular to a direction of movement of carbon nanotube wire 200. Fourth tube 44 defines a flow channel that communicates with the inside of waste liquid container 6. A liquid mixture of chlorosulfonic acid and coagulant liquid 92 is collected in waste liquid container 6.

First supply portion 1 includes a first container 61 and a first tube pump 51. First container 61 communicates with first tube 10. Slurry 94 is accommodated in first container 61. Slurry 94 is a liquid obtained by dispersion of a carbon nanotube source material in chlorosulfonic acid. The carbon nanotube source material is, for example, in a fibrous shape. First container 61 may be configured such that slurry 94 can be made by mixing the carbon nanotube source material and chlorosulfonic acid. Specifically, first container 61 may be configured such that the carbon nanotube source material and chlorosulfonic acid are agitated while they are heated. First container 61 may include a heating portion (not shown) and an agitation portion (not shown).

As shown in FIG. 1, first tube pump 51 is attached to first tube 10. From another point of view, a part of first tube 10 is arranged inside first tube pump 51. First tube pump 51 is configured to deliver a liquid located inside first tube 10 in a direction shown with a second arrow A2. Second arrow A2 indicates a direction from first supply portion 1 toward second tube 20. First tube 10 is, for example, linear. The direction shown with second arrow A2 is substantially in parallel to the direction of extension of first tube 10.

Second supply portion 2 includes a second container 62, a fifth tube 45, and a second tube pump 52. Coagulant liquid 92 is accommodated in second container 62. Fifth tube 45 allows communication between the inside of second container 62 and the inside of first connection portion 30. Second tube pump 52 is attached to fifth tube 45. From another point of view, a part of fifth tube 45 is arranged inside second pump 52. Second tube pump 52 is configured to deliver a liquid located inside fifth tube 45 in a direction shown with a third arrow A3. Third arrow A3 indicates a direction from second supply portion 2 toward second tube 20.

First tube 10 includes first outer circumferential surface 11, first inner circumferential surface 12, a first end 13, and a third end 14. First inner circumferential surface 12 is located opposite to first outer circumferential surface 11. First end 13 is arranged inside second tube 20. Third end 14 is located opposite to first end 13. Third end 14 is attached to first container 61.

In first tube 10, a point located at an outlet of first tube pump 51 is defined as an intermediate point 15. From another point of view, in a portion of first tube 10 arranged between first tube pump 51 and second tube 20, a point closest to first tube pump 51 is defined as intermediate point 15. In a direction of extension of first inner circumferential surface 12, a length between intermediate point 15 and first end 13 is defined as a first length D1. First length D1 is, for example, not shorter than 500 mm and not longer than 10000 mm. The direction of extension of first inner circumferential surface 12 is a direction from third end 14 toward first end 13 along first inner circumferential surface 12.

Second tube 20 is, for example, linear. Second tube 20 includes a second outer circumferential surface 21, a second inner circumferential surface 22, a second end 23, and a fourth end 24. Second inner circumferential surface 22 is located opposite to second outer circumferential surface 21. Second inner circumferential surface 22 extends along first outer circumferential surface 11. Fourth end 24 is attached to first connection portion 30. In the direction of extension of first inner circumferential surface 12, fourth end 24 is located, for example, between first end 13 and third end 14. In the direction of extension of first inner circumferential surface 12, fourth end 24 may be located at a position substantially the same as first end 13. Second end 23 is located opposite to fourth end 24. Second end 23 is located opposite to second supply portion 2. From another point of view, a liquid supplied from second supply portion 2 reaches second end 23 through fourth end 24. Second end 23 is attached to second connection portion 40.

A length between first end 13 and second end 23 in the direction of extension of second inner circumferential surface 22 is defined as a second length D2. Second length D2 is, for example, not shorter than 10 mm and not longer than 2000 mm. Though a lower limit of second length D2 is not particularly limited, it may be, for example, not shorter than 50 mm or not shorter than 100 mm. Though an upper limit of second length D2 is not particularly limited, it may be, for example, not longer than 1500 mm or not longer than 1000 mm. The direction of extension of second inner circumferential surface 22 is a direction from fourth end 24 toward second end 23 along second inner circumferential surface 22. Second length D2 may be longer than first length D1.

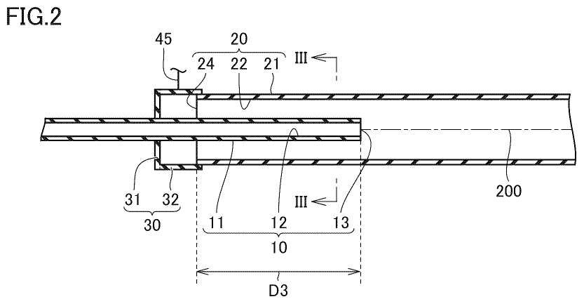

FIG. 2 is an enlarged schematic cross-sectional view showing a region II in FIG. 1. The cross-section shown in FIG. 2 is a cross-section in parallel to the direction of extension of first inner circumferential surface 12 and intersecting with first tube 10 and second tube 20. As shown in FIG. 2, first connection portion 30 includes a first portion 31 and a second portion 32. First portion 31 surrounds first tube 10. First portion 31 is in contact with first tube 10. First portion 31 extends along a direction (a radial direction) perpendicular to the direction of extension of first inner circumferential surface 12.

Second portion 32 is contiguous to first portion 31. Second portion 32 extends along the direction of extension of first inner circumferential surface 12. Second portion 32 surrounds first tube 10. Second portion 32 is distant from first tube 10. Second portion 32 may surround fourth end 24 of second tube 20. At second outer circumferential surface 21, second portion 32 may be in contact with second tube 20. In second portion 32, a through hole (not shown) is provided. The through hole extends along the radial direction. In the through hole, fifth tube 45 is attached. In other words, the inside of fifth tube 45 and the inside of second portion 32 are contiguous through the through hole. In each of first tube 10 and second tube 20, on the other hand, a through hole that extends in the radial direction is not provided.

A length of a portion of first tube 10 arranged inside second tube 20 is defined as a third length D3. From another point of view, third length D3 is a length between fourth end 24 of second tube 20 and first end 13 of first tube 10 in the direction of extension of first inner circumferential surface 12. Third length D3 is, for example, not shorter than 0 mm and not longer than 300 mm. Though a lower limit of third length D3 is not particularly limited, it may be, for example, not shorter than 5 mm or not shorter than 10 mm. Though an upper limit of third length D3 is not particularly limited, it may be, for example, not longer than 200 mm or not longer than 150 mm.

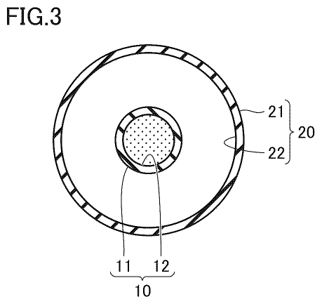

FIG. 3 is a schematic cross-sectional view along the line III-III in FIG. 2. The cross-section shown in FIG. 3 is a cross-section perpendicular to the direction of extension of first inner circumferential surface 12 and intersecting with each of first tube 10 and second tube 20. As shown in FIG. 3, first tube 10 is in an annular shape. When viewed in the direction of extension of first inner circumferential surface 12, first inner circumferential surface 12 is, for example, circular. First outer circumferential surface 11 surrounds first inner circumferential surface 12. Second tube 20 is in an annular shape. When viewed in the direction of extension of first inner circumferential surface 12, second inner circumferential surface 22 is, for example, circular. Second inner circumferential surface 22 surrounds first outer circumferential surface 11. Second inner circumferential surface 22 is distant from first outer circumferential surface 11. Second outer circumferential surface 21 surrounds second inner circumferential surface 22.

A region shown with a plurality of dots in FIG. 3 represents a region surrounded by first inner circumferential surface 12. In the cross-section perpendicular to the direction of extension of second inner circumferential surface 22 and intersecting with each of first tube 10 and second tube 20, an area of the region surrounded by first inner circumferential surface 12 is defined as a first area. In other words, the first area is an area of the region shown with the plurality of dots in FIG. 3. The first area is, for example, not smaller than 0.008 mm² and not larger than 16 mm².

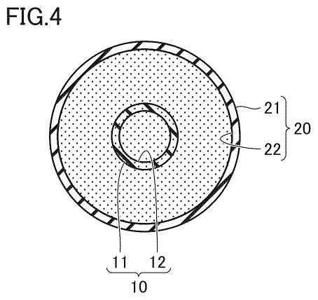

FIG. 4 is a schematic cross-sectional view showing a region surrounded by second inner circumferential surface 22. The cross-section shown in FIG. 4 corresponds to the cross-section shown in FIG. 3. A region shown with a plurality of dots in FIG. 4 represents a region surrounded by second inner circumferential surface 22. In the cross-section perpendicular to the direction of extension of second inner circumferential surface 22 and intersecting with each of first tube 10 and second tube 20, an area of the region surrounded by second inner circumferential surface 22 is defined as a second area. In other words, the second area is an area of the region shown with the plurality of dots in FIG. 4. The second area is, for example, not smaller than 1 mm² and not larger than 80 mm².

A value calculated by dividing the first area by the second area is, for example, not smaller than 0.0001 and not larger than 0.2. Though a lower limit of the value calculated by dividing the first area by the second area is not particularly limited, it may be, for example, not smaller than 0.001 or not smaller than 0.01. Though an upper limit of the value calculated by dividing the first area by the second area is not particularly limited, it may be, for example, not larger than 0.1 or not larger than 0.05.

### (Method of Manufacturing Carbon Nanotube Wire)

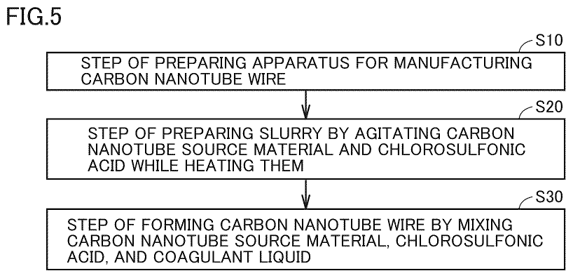

A method of manufacturing a carbon nanotube wire according to the first embodiment will now be described. FIG. 5 is a flowchart schematically showing the method of manufacturing a carbon nanotube wire according to the first embodiment. As shown in FIG. 5, the method of manufacturing a carbon nanotube wire mainly includes steps of preparing apparatus 100 for manufacturing a carbon nanotube wire (S10), preparing slurry 94 by agitating a carbon nanotube source material and chlorosulfonic acid while heating them (S20), and forming carbon nanotube wire 200 by mixing the carbon nanotube source material, chlorosulfonic acid, and coagulant liquid 92 (S30).

The step of preparing apparatus 100 for manufacturing a carbon nanotube wire (S10) is initially performed. Apparatus 100 for manufacturing a carbon nanotube wire shown in FIG. 1 is prepared.

Then, the step of preparing slurry 94 by agitating a carbon nanotube source material and chlorosulfonic acid while heating them (S20) is performed. The carbon nanotube source material and chlorosulfonic acid are introduced to the inside of first container 61.

In first container 61, the carbon nanotube source material and chlorosulfonic acid are agitated while they are heated. In the step of preparing slurry 94 (S20), a heating temperature of the carbon nanotube source material and chlorosulfonic acid is set, for example, to 120° C. The heating temperature may be, for example, not lower than 100° C. and not higher than 150° C. When the heating temperature is excessively high, chlorosulfonic acid may thermally be decomposed, and hence the heating temperature is desirably within the range above.

A concentration of the carbon nanotube source material in slurry 94 is not lower than 0.01 weight % and not higher than 3 weight %. The concentration of the carbon nanotube source material in slurry 94 is expressed as a value calculated by dividing a weight of the carbon nanotube source material by a total of a weight of chlorosulfonic acid and the weight of the carbon nanotube source material. Though a lower limit of the concentration of the carbon nanotube source material in slurry 94 is not particularly limited, it may be, for example, not lower than 0.05 weight % or not lower than 0.1 weight %. Though an upper limit of the concentration of the carbon nanotube source material in slurry 94 is not particularly limited, it may be, for example, not higher than 1 weight % or not higher than 0.5 weight %. Slurry 94 is prepared as set forth above.

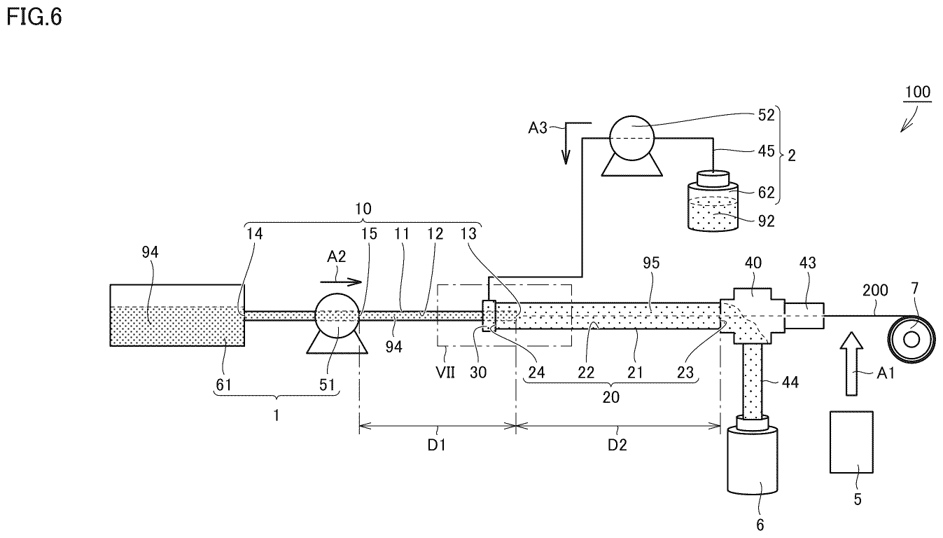

Then, the step of forming carbon nanotube wire 200 by mixing the carbon nanotube source material, chlorosulfonic acid, and coagulant liquid 92 (S30) is performed. FIG. 6 is a schematic front view showing the step of forming carbon nanotube wire 200 (S30). In FIG. 6, a region shown with a plurality of dots represents a liquid.

As shown in FIG. 6, first tube pump 51 is used to supply slurry 94 from first container 61 to the inside of first tube 10. Slurry 94 flows in the direction shown with second arrow A2. The carbon nanotube source material contained in slurry 94 thus receives shearing force originating from the flow of slurry 94. Therefore, the carbon nanotube source material is oriented such that a longitudinal direction thereof extends along the direction of extension of first inner circumferential surface 12.

In the step of forming carbon nanotube wire 200 (S30), a flow rate of slurry 94 that flows inside first tube 10 is set to a first flow rate. The first flow rate is, for example, not lower than 0.001 cm³/minute and not higher than 5 cm³/minute. Though a lower limit of the first flow rate is not particularly limited, it may be, for example not lower than 0.005 cm³/minute or not lower than 0.009 cm³/minute. Though an upper limit of the first flow rate is not particularly limited, it may be, for example, not higher than 1 cm³/minute or not higher than 0.6 cm³/minute.

Second tube pump 52 is used to supply coagulant liquid 92 from second container 62 to the inside of fifth tube 45. Coagulant liquid 92 flows along third arrow A3. Coagulant liquid 92 flows to the inside of second tube 20 through fifth tube 45 and first connection portion 30.

Slurry 94 and coagulant liquid 92 are mixed by merging inside second tube 20. Chlorosulfonic acid contained in slurry 94 is dissolved in coagulant liquid 92. A liquid mixture 95 is thus produced. Liquid mixture 95 flows into waste liquid container 6 through each of second tube 20, second connection portion 40, and fifth tube 45.

In the step of forming carbon nanotube wire 200 (S30), a flow rate of liquid mixture 95 that flows inside second tube 20 is set to a second flow rate. The second flow rate is, for example, not lower than 0.02 cm³/minute and not higher than 100 cm³/minute. Though a lower limit of the second flow rate is not particularly limited, it may be, for example, not lower than 0.1 cm³/minute or not lower than 0.5 cm³/minute. Though an upper limit of the second flow rate is not particularly limited, it may be, for example, not higher than 10 cm³/minute or not higher than 1 cm³/minute. The first flow rate is lower than the second flow rate. A value calculated by dividing the first flow rate by the second flow rate is, for example, not smaller than 0.00001 and not larger than 0.05.

The carbon nanotube source material contained in slurry 94 linearly coagulates. Carbon nanotube wire 200 is thus formed. Carbon nanotube wire 200 is wound up around first bobbin 7 through each of second tube 20, second connection portion 40, and third tube 43. Carbon nanotube wire 200 is dried with heat gun 5, between third tube 43 and first bobbin 7.

First bobbin 7 winds up formed carbon nanotube wire 200 by rotating. From another point of view, first bobbin 7 applies tension to carbon nanotube wire 200. In the step of forming carbon nanotube wire 200 (S30), the number of rotations of first bobbin 7 is not less than 1 rpm and not more than 1000 rpm. Though a lower limit of the number of rotations of first bobbin 7 is not particularly limited, it may be, for example, not less than 5 rpm or not less than 10 rpm. Though an upper limit of the number of rotations of first bobbin 7 is not particularly limited, it may be, for example, not more than 500 rpm or not more than 100 rpm.

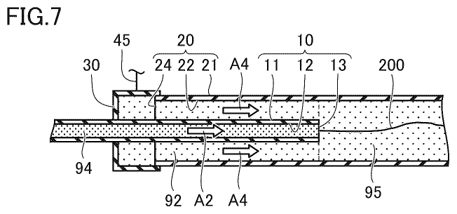

FIG. 7 is an enlarged schematic cross-sectional view showing a region VII in FIG. 6. The cross-section shown in FIG. 7 corresponds to the cross-section shown in FIG. 2. As shown in FIGS. 6 and 7, slurry 94 flows along second arrow A2. Slurry 94 flows to the inside of second tube 20 through first end 13. Coagulant liquid 92 surrounds first tube 10 on the inside of first connection portion 30. Coagulant liquid 92 flows from first connection portion 30 through fourth end 24 into second tube 20. Coagulant liquid 92 flows along a fourth arrow A4. A direction shown with fourth arrow A4 is the direction of extension of second inner circumferential surface 22. A direction of the flow of coagulant liquid 92 may be substantially in parallel to the direction of flow of slurry 94.

As shown in FIG. 7, between fourth end 24 and first end 13, slurry 94 and coagulant liquid 92 are separated by first tube 10. Between first end 13 and second end 23 (see FIG. 6), slurry 94 and coagulant liquid 92 merge with each other. Slurry 94 that flows out of first end 13 is mixed with coagulant liquid 92 around first end 13. In a region downstream from first end 13, the carbon nanotube source material is further oriented to form carbon nanotube wire 200.

Carbon nanotube wire 200 is made as set forth above. A length of one carbon nanotube wire 200 is, for example, not shorter than 100 m and not longer than 100000 m. The length of one carbon nanotube wire 200 may be, for example, not shorter than 1000 m. The diameter of carbon nanotube wire 200 is, for example, not smaller than 10 μm and not larger than 100 μm.

### Second Embodiment

A configuration of apparatus 100 for manufacturing a carbon nanotube wire according to a second embodiment will now be described. Apparatus 100 for manufacturing a carbon nanotube wire according to the second embodiment is different in configuration from apparatus 100 for manufacturing a carbon nanotube wire according to the first embodiment mainly in including a second bobbin 8 that supplies a linear carbon nanotube source material 91 and it is otherwise substantially identical in configuration to apparatus 100 for manufacturing a carbon nanotube wire according to the first embodiment. Differences in configuration from apparatus 100 for manufacturing a carbon nanotube wire according to the first embodiment will mainly be described below.

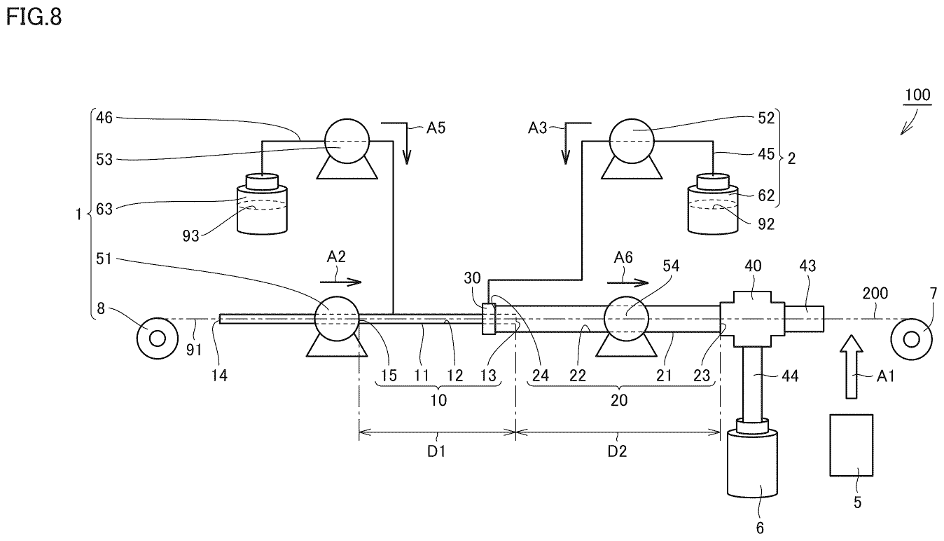

FIG. 8 is a schematic diagram showing the configuration of apparatus 100 for manufacturing a carbon nanotube wire according to the second embodiment. As shown in FIG. 8, first supply portion 1 may include second bobbin 8, a third container 63, a third tube pump 53, and a sixth tube 46.

Carbon nanotube source material 91 is wound around second bobbin 8. Carbon nanotube source material 91 has a linear shape. Carbon nanotube source material 91 is synthesized, for example, with a honeycomb method. First tube pump 51 is configured to supply carbon nanotube source material 91 from second bobbin 8 to the inside of first tube 10.

Chlorosulfonic acid 93 is accommodated in third container 63. Sixth tube 46 defines a flow channel of chlorosulfonic acid 93. Sixth tube 46 allows communication between the inside of third container 63 and the inside of first tube 10. At a portion of first tube 10 between first end 13 and intermediate point 15, sixth tube 46 is connected to first tube 10.

Third tube pump 53 is attached to sixth tube 46. Third tube pump 53 is configured to supply chlorosulfonic acid 93 to first tube 10 along a fifth arrow A5. Fifth arrow A5 indicates a direction from third container 63 toward first tube 10.

As shown in FIG. 8, apparatus 100 for manufacturing a carbon nanotube wire may include a fourth tube pump 54. Fourth tube pump 54 is attached to second tube 20. In the direction of extension of second inner circumferential surface 22, fourth tube pump 54 is arranged between first end 13 and second end 23. Fourth tube pump 54 is configured to deliver carbon nanotube wire 200 and liquid mixture 95 (see FIG. 6) along a sixth arrow A6. Sixth arrow A6 indicates a direction from fourth end 24 toward second end 23. The direction indicated by sixth arrow A6 is substantially in parallel to a direction of extension of second tube 20. The direction indicated by sixth arrow A6 may substantially be in parallel to fourth arrow A4 (see FIG. 7).

In the inside of first tube 10, carbon nanotube source material 91 is immersed in chlorosulfonic acid 93. Carbon nanotube source material 91 is thus loosened. Loosened carbon nanotube source material 91 receives shearing force originating from the flow of chlorosulfonic acid 93. Carbon nanotube source material 91 is thus oriented.

Slurry obtained by mixing of chlorosulfonic acid 93 and carbon nanotube source material 91 is sent to second tube 20. Slurry merges with coagulant liquid 92 on the inside of second tube 20. Carbon nanotube source material 91 is thus coagulated. Consequently, carbon nanotube wire 200 is formed.

Functions and effects of apparatus 100 for manufacturing a carbon nanotube wire and the method of manufacturing a carbon nanotube wire according to the present embodiment will now be described.

When the direction of flow of slurry 94 and the direction of flow of coagulant liquid 92 are orthogonal to each other in merge of slurry 94 and coagulant liquid 92, due to the flow of coagulant liquid 92, carbon nanotube wire 200 formed as a result of coagulation of carbon nanotubes flows along the direction perpendicular to a direction of extension of carbon nanotube wire 200. Therefore, the shape of carbon nanotube wire 200 is distorted and carbon nanotube wire 200 is entangled. Clogging with carbon nanotubes in the tube thus occurs.

Apparatus 100 for manufacturing a carbon nanotube wire according to the present embodiment includes first tube 10 and second tube 20. Second inner circumferential surface 22 of second tube 20 extends along first outer circumferential surface 11 of first tube 10. First end 13 of first tube 10 is arranged inside second tube 20. Therefore, before slurry 94 and coagulant liquid 92 merge, the flow of each of slurry 94 and coagulant liquid 92 is rectified along the direction of extension of second inner circumferential surface 22. Therefore, carbon nanotube wire 200 is formed along the direction of extension of second inner circumferential surface 22, and formed carbon nanotube wire 200 flows in the direction of extension of second inner circumferential surface 22. Entanglement of carbon nanotube wire 200 can thus be suppressed. Consequently, clogging with carbon nanotubes in apparatus 100 for manufacturing a carbon nanotube wire can be suppressed.

According to apparatus 100 for manufacturing a carbon nanotube wire according to the present embodiment, coagulant liquid 92 contains acetone. Chlorosulfonic acid is highly soluble in acetone. Therefore, in mixing of the carbon nanotube source material, chlorosulfonic acid, and coagulant liquid 92, coagulation of the carbon nanotube source material can be promoted. Consequently, the flow rate of slurry can be increased. Therefore, the degree of orientation of carbon nanotube wire 200 can be improved.

Apparatus 100 for manufacturing a carbon nanotube wire according to the present disclosure includes a portion where the carbon nanotube source material and chlorosulfonic acid are agitated while they are heated. Therefore, the carbon nanotube source material can more uniformly be dispersed in slurry 94. The degree of orientation of carbon nanotube wire 200 can thus be improved.

According to apparatus 100 for manufacturing a carbon nanotube wire according to the present disclosure, a length (third length D3) of the portion of first tube 10 arranged inside second tube 20 is equal to or larger than 0 mm. Therefore, in merge of slurry 94 and coagulant liquid 92, the flow of each of slurry 94 and coagulant liquid 92 is further rectified along the direction of extension of second inner circumferential surface 22. Consequently, clogging with carbon nanotubes can further be suppressed.

### Example 1

### (Preparation of Sample)

Carbon nanotube wires 200 according to samples 1 to 4 were initially prepared. Carbon nanotube wires 200 according to samples 1 to 4 fall under Example.

Carbon nanotube wires 200 according to samples 1 to 4 were made with the above-described method of manufacturing a carbon nanotube wire. In making carbon nanotube wire 200 according to sample 1, the length (second length D2) between first end 13 and second end 23 in the direction of extension of second inner circumferential surface 22 was set to 1000 mm. The length (third length D3) of the portion of first tube 10 arranged inside second tube 20 was set to 150 mm. The concentration of the carbon nanotube source material in slurry 94 was set to 1 weight %. Acetone was adopted as coagulant liquid 92. The flow rate of coagulant liquid 92 was set to 10 cm³/minute.

In making carbon nanotube wire 200 according to sample 1, the flow rate of slurry 94 was set to 0.01 cm³/minute. In making carbon nanotube wire 200 according to sample 2, the flow rate of slurry 94 was set to 0.08 cm³/minute. In making carbon nanotube wire 200 according to sample 3, the flow rate of slurry 94 was set to 0.15 cm³/minute. In making carbon nanotube wire 200 according to sample 4, the flow rate of slurry 94 was set to 0.5 cm³/minute.

### (Evaluation Method 1)

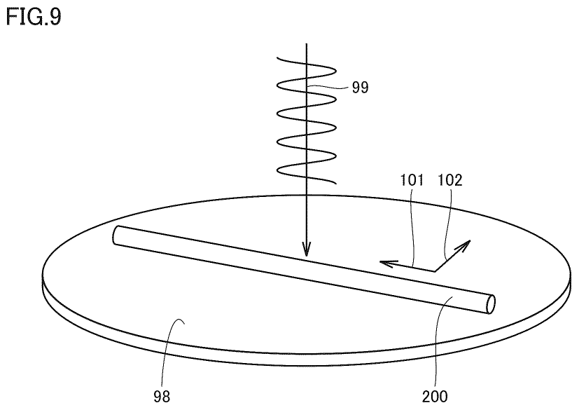

The degree of orientation of carbon nanotube wire 200 according to each of sample 1 to sample 4 was then evaluated with polarized Raman spectroscopy. FIG. 9 is a schematic perspective view showing a method of evaluating the degree of orientation with polarized Raman spectroscopy. As shown in FIG. 9, carbon nanotube wire 200 was arranged on a sample base 98. The direction of extension of carbon nanotube wire 200 is defined as a first direction 101. A direction perpendicular to first direction 101 and along sample base 98 is defined as a second direction 102.

Carbon nanotube wire 200 was irradiated with polarized laser beams 99. Raman spectra were obtained by measuring intensity of Raman scattered light from carbon nanotube wire 200. Laser beams 99 were emitted along a direction perpendicular to each of first direction 101 and second direction 102. An excitation wavelength of laser beams 99 was set to 532 nm.

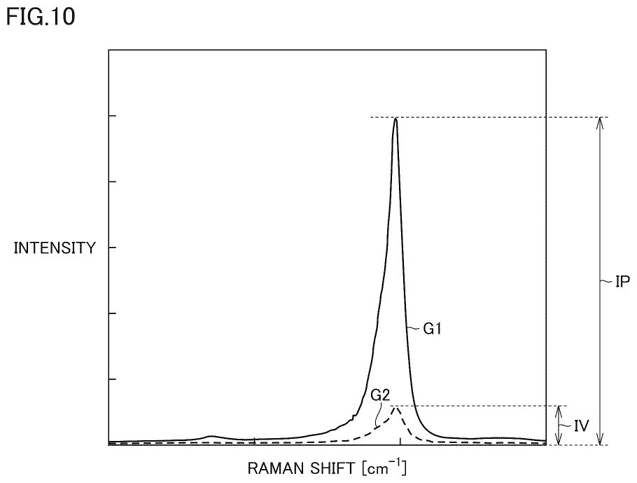

FIG. 10 is a schematic diagram showing Raman spectra. In FIG. 10, the abscissa represents a Raman shift. The Raman shift is a value obtained by subtracting a frequency of incident laser beams 99 from a frequency of measured Raman scattered light. The ordinate represents intensity of Raman scattered light. In FIG. 10, a first spectrum G1 represents a Raman spectrum when a direction of polarization of laser beams 99 was set to first direction 101. A second spectrum G2 represents a Raman spectrum when the direction of polarization of laser beams 99 was set to second direction 102.

A peak value of intensity was calculated from the obtained Raman spectrum. The peak value in first spectrum G1 was defined as a first value IP. The peak value in second spectrum G2 was defined as a second value IV. As carbon nanotube wire 200 is oriented in first direction 101 to a greater extent, first value IP is larger and second value IV is smaller. A value (IP/IV) obtained by dividing first value IP by second value IV was adopted as an evaluation index of the degree of orientation of carbon nanotube wire 200.

### (Evaluation Result 1)

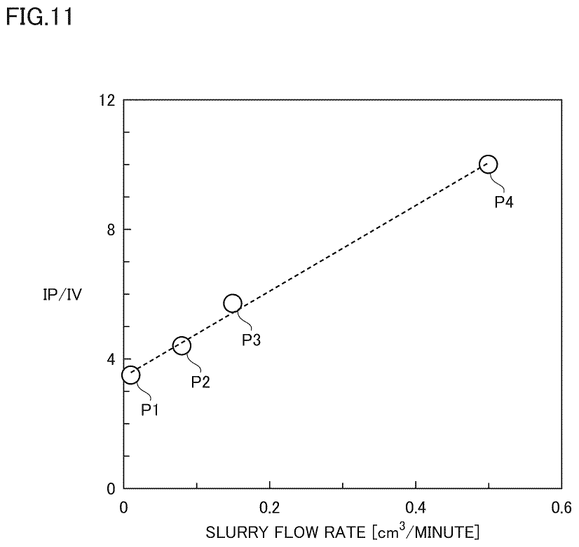

FIG. 11 is a diagram showing relation between the flow rate of slurry 94 and the degree of orientation of carbon nanotube wire 200 in Example. In FIG. 11, the abscissa represents the flow rate of slurry 94. The ordinate represents IP/IV. A first plot P1 shown in FIG. 11 shows a result of measurement of carbon nanotube wire 200 according to sample 1. A second plot P2 shows a result of measurement of carbon nanotube wire 200 according to sample 2. A third plot P3 shows a result of measurement of carbon nanotube wire 200 according to sample 3. A fourth plot P4 shows a result of measurement of carbon nanotube wire 200 according to sample 4.

As shown in FIG. 11, IP/IV of carbon nanotube wire 200 according to sample 1 was not smaller than three and not larger than four. IP/IV of carbon nanotube wire 200 according to sample 2 was not smaller than four and not larger than five. IP/IV of carbon nanotube wire 200 according to sample 3 was not smaller than five and not larger than six. IP/IV of carbon nanotube wire 200 according to sample 4 was not smaller than nine and not larger than eleven.

It could be confirmed from the results above that, as the flow rate of slurry 94 was higher, IP/IV was larger as shown in FIG. 11. It could be confirmed that relation between the flow rate of slurry 94 and IP/IV could linearly be approximated within a range where the flow rate of slurry 94 was not lower than 0.01 cm³/minute and not higher than 0.5 cm³/minute.

### (Evaluation Method 2)

Carbon nanotube wire 200 according to each of samples 1 and 4 was observed with a scanning electron microscope (SEM).

### (Evaluation Result 2)

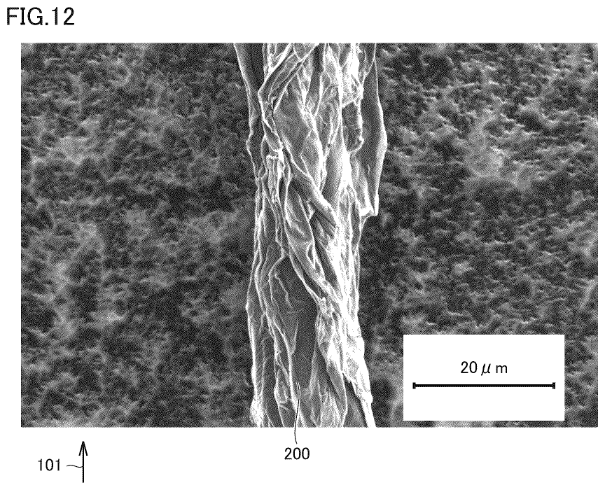

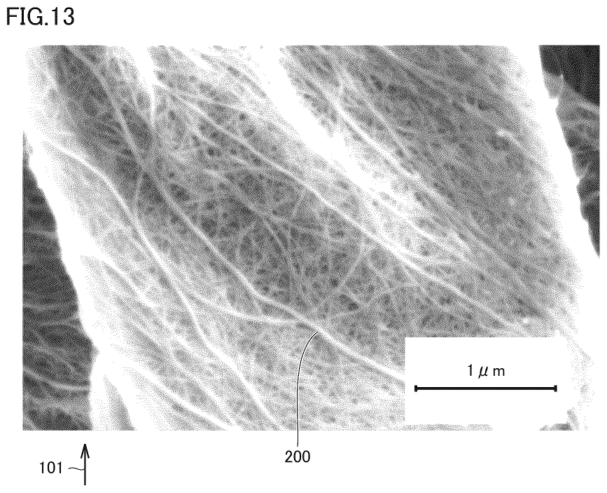

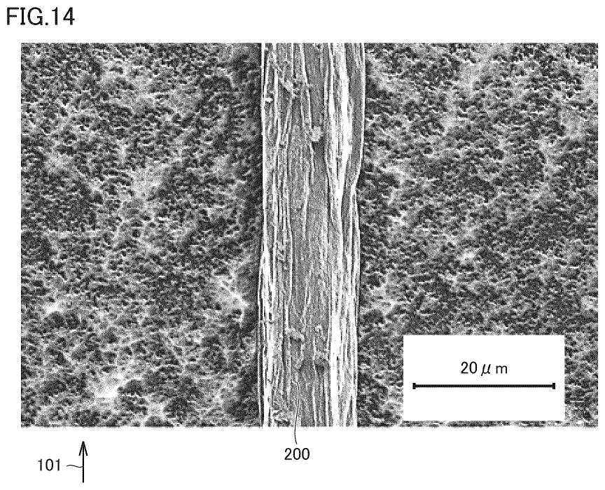

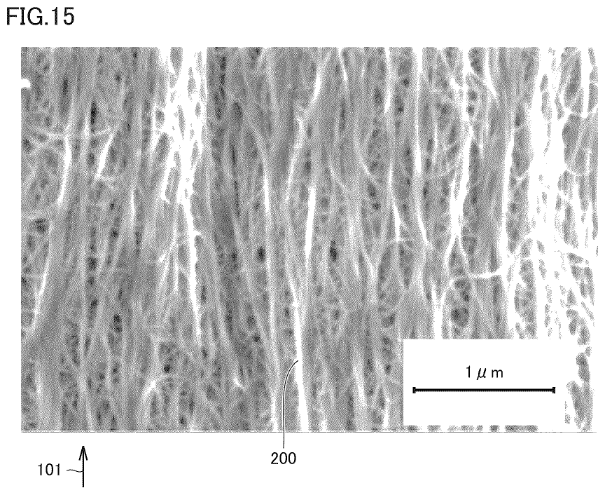

FIG. 12 is a scanning electron micrograph of carbon nanotube wire 200 according to sample 1. FIG. 13 is a scanning electron micrograph showing a surface of carbon nanotube wire 200 according to sample 1, as being enlarged. FIG. 14 is a scanning electron micrograph of carbon nanotube wire 200 according to sample 4. FIG. 15 is a scanning electron micrograph showing a surface of carbon nanotube wire 200 according to sample 4, as being enlarged.

As shown in FIGS. 12 and 13, a direction of extension of fibers that form carbon nanotube wire 200 according to sample 1 is inclined with respect to the direction of extension of carbon nanotube wire 200 (first direction 101). As shown in FIGS. 14 and 15, on the other hand, a direction of extension of fibers that form carbon nanotube wire 200 according to sample 4 extends along first direction 101.

As shown in FIGS. 12 and 14, carbon nanotube wire 200 according to sample 4 has less surface irregularities than carbon nanotube wire 200 according to sample 1.

It could be confirmed from the results above that, with increase in flow rate of slurry 94, surface irregularities of carbon nanotube wire 200 were less and the degree of orientation of carbon nanotube wire 200 was improved.

### Example 2

### (Preparation of Sample)

Carbon nanotube wires 200 according to samples 5 to 7 were initially prepared. Carbon nanotube wires 200 according to samples 5 and 6 fall under Comparative Example. Carbon nanotube wire 200 according to sample 7 falls under Example. Carbon nanotube wires 200 according to samples 5 to 7 were made with the above-described method of manufacturing carbon nanotube wire 200.

In making carbon nanotube wire 200 according to sample 5, chloroform was adopted as coagulant liquid 92. In making carbon nanotube wire 200 according to sample 6, water was adopted as coagulant liquid 92. In making carbon nanotube wire 200 according to sample 7, acetone was adopted as coagulant liquid 92.

### (Evaluation Method)

In making carbon nanotube wires 200 according to samples 5 to 7, a solubility of chlorosulfonic acid in coagulant liquid 92 was checked. Specifically, whether or not the carbon nanotube source material was linearly coagulable when the flow rate of slurry 94 was increased was checked. As the solubility of chlorosulfonic acid in coagulant liquid 92 is higher, the flow rate of slurry 94 at which the carbon nanotube source material is linearly coagulable increases. The solubility of the carbon nanotube source material in coagulant liquid 92 was checked. Chemical reaction between coagulant liquid 92 and slurry 94 that affected manufacturing of carbon nanotube wire 200 was visually checked.

### (Evaluation Result)

TABLE 1

| | Coagulant | Solubility of | Solubility of | Chemical |
|---|---|---|---|---|
| | Liquid | CSA | CNT | Reaction |
| Sample 5 | Chloroform | B | A | A |
| Sample 6 | Water | A | A | B |
| Sample 7 | Acetone | A | A | A |

Table 1 shows the solubility of each of chlorosulfonic acid (CSA) and the carbon nanotube source material (CNT) in coagulant liquid 92 and whether chemical reaction that affected manufacturing of carbon nanotube wire 200 occurred in making of carbon nanotube wires 200 according to samples 5 to 7.

In the field of the solubility of CSA in Table 1, A indicates that solution of chlorosulfonic acid in the coagulant liquid was fast. B indicates that solution of chlorosulfonic acid in the coagulant liquid was slow. In the field of the solubility of CNT in Table 1, A indicates that solution of the carbon nanotube source material in the coagulant liquid was not observed. In the field of the chemical reaction in Table 1, A indicates that no chemical reaction that affected manufacturing of carbon nanotube wire 200 was observed. B indicates that the chemical reaction that affected manufacturing of carbon nanotube wire 200 was observed.

As shown in Table 1, in sample 6, the chemical reaction between chlorosulfonic acid and the coagulant liquid was observed. Specifically, chlorosulfonic acid and water vigorously reacted and heat was generated. In sample 7, chemical reaction which is discoloration of liquid mixture 95 in mixing of chlorosulfonic acid and the coagulant liquid was observed, however, influence on manufacturing of carbon nanotube wire 200 was not observed.

It was confirmed from the results above that acetone was desirably employed as coagulant liquid 92 in the method of manufacturing carbon nanotube wire 200.

It should be understood that the embodiments and the examples disclosed herein are illustrative and non-restrictive in every respect. The scope of the present invention is defined by the terms of the claims rather than the embodiments above and is intended to include any modifications within the scope and meaning equivalent to the terms of the claims.

### REFERENCE SIGNS LIST

1 first supply portion; 2 second supply portion; 5 heat gun; 6 waste liquid container; 7 first bobbin (bobbin); 8 second bobbin; 10 first tube; 11 first outer circumferential surface (outer circumferential surface); 12 first inner circumferential surface; 13 first end; 14 third end; 15 intermediate point; 20 second tube; 21 second outer circumferential surface; 22 second inner circumferential surface; 23 second end; 24 fourth end; 30 first connection portion; 31 first portion; 32 second portion; 40 second connection portion; 43 third tube; 44 fourth tube; 45 fifth tube; 46 sixth tube; 51 first tube pump; 52 second tube pump; 53 third tube pump; 54 fourth tube pump; 61 first container; 62 second container; 63 third container; 91 carbon nanotube source material; 92 coagulant liquid; 93 chlorosulfonic acid; 94 slurry; 95 liquid mixture; 98 sample base; 99 laser beam; 100 manufacturing apparatus; 101 first direction; 102 second direction; 200 carbon nanotube wire; A1 first arrow; A2 second arrow; A3 third arrow; A4 fourth arrow; A5 fifth arrow; A6 sixth arrow; D1 first length; D2 second length; D3 third length; G1 first spectrum; G2 second spectrum; IP first value; IV second value; P1 first plot; P2 second plot; P3 third plot; P4 fourth plot.

1. An apparatus for manufacturing a carbon nanotube wire comprising:
a first tube including a first inner circumferential surface and an outer circumferential surface that surrounds the first inner circumferential surface;
a second tube including a second inner circumferential surface that surrounds the outer circumferential surface and extends along the outer circumferential surface;
a first supply portion that supplies a carbon nanotube source material and chlorosulfonic acid to inside of the first tube; and
a second supply portion that supplies a coagulant liquid to inside of the second tube, wherein
the first tube includes a first end arranged inside the second tube.

2. The apparatus for manufacturing a carbon nanotube wire according to claim 1, wherein
the coagulant liquid contains acetone.

3. The apparatus for manufacturing a carbon nanotube wire according to claim 1, further comprising a portion where the carbon nanotube source material and the chlorosulfonic acid are agitated while the carbon nanotube source material and chlorosulfonic acid are heated.

4. The apparatus for manufacturing a carbon nanotube wire according to claim 1, wherein
a value calculated by dividing a first area by a second area is not smaller than 0.0001 and not larger than 0.2, the first area representing an area of a region surrounded by the first inner circumferential surface in a cross-section perpendicular to a direction of extension of the second inner circumferential surface and intersecting with each of the first tube and the second tube, the second area representing an area of a region surrounded by the second inner circumferential surface in the cross-section.

5. The apparatus for manufacturing a carbon nanotube wire according to claim 1, wherein
a length of a portion of the first tube arranged inside the second tube is not shorter than 0 mm and not longer than 300 mm.

6. The apparatus for manufacturing a carbon nanotube wire according to claim 1, wherein
the second tube includes a second end arranged opposite to the second supply portion, and
a length between the first end and the second end in a direction of extension of the second inner circumferential surface is not shorter than 10 mm and not longer than 2000 mm.

7. A method of manufacturing a carbon nanotube wire comprising:
preparing the apparatus for manufacturing a carbon nanotube wire according to claim 1; and
mixing the carbon nanotube source material, the chlorosulfonic acid, and the coagulant liquid by supplying the coagulant liquid to the inside of the second tube while the carbon nanotube source material and the chlorosulfonic acid are supplied to the inside of the first tube.

8. The method of manufacturing a carbon nanotube wire according to claim 7, wherein
in the mixing, a flow rate of a liquid that flows inside the first tube is not lower than 0.001 cm³/minute and not higher than 5 cm³/minute.

9. The method of manufacturing a carbon nanotube wire according to claim 7, wherein
in the mixing, a flow rate of a liquid that flows inside the second tube is not lower than 0.02 cm³/minute and not higher than 100 cm³/minute.

10. The method of manufacturing a carbon nanotube wire according to claim 7, wherein
a carbon nanotube wire formed in the mixing is wound up by using a bobbin, and
the number of rotations of the bobbin is not less than 1 rpm and not more than 1000 rpm.

11. The method of manufacturing a carbon nanotube wire according to claim 7, comprising, prior to the mixing, preparing slurry by agitating the carbon nanotube source material and the chlorosulfonic acid while heating the carbon nanotube source material and the chlorosulfonic acid, wherein
a concentration of the carbon nanotube source material in the slurry is not lower than 0.01 weight % and not higher than 3 weight %.
